(19) United States
(12) Patent Application Publication
(10) Pub. No.: US 2010/0134004 A1
(43) Pub. Date: Jun. 3, 2010

(54) HOT-CATHODE FLUORESCENT LAMP

(76) Inventors: Shiro Otake, Osaka (JP); Teruaki Shigeta, Osaka (JP); Nobuhiro Shimizu, Nara (JP)

Correspondence Address: SNELL & WILMER L.L.P. (Panasonic), 600 ANTON BOULEVARD, SUITE 1400, COSTA MESA, CA, 92626, US

(21) Appl. No.: 12/443,687

(22) PCT Filed: Nov. 2, 2007
(86) PCT No.: PCT/JP2007/071418

§ 371 Date: Mar. 30, 2009

(30) Foreign Application Priority Data
Nov. 2, 2006 (JP) 2006-299663

(51) Int. Cl. H01J 61/067

(52) U.S. Cl. 313/631

(57) ABSTRACT

The present invention provides a hot cathode discharge lamp comprising an electrode that has a filament coil, a first and a second connection-reinforcing members (5a) and (5b), a first and a second lead-in wires (6a) and (6b), the filament coil including: a coil part (4a); a first lead wire (4b) connected to the first lead-in wire (6a) via the first connection-reinforcing member (5a); and a second lead wire (4c) connected to the second lead-in wire (6b) via the second connection-reinforcing member (5b), wherein a first plane of the first connection-reinforcing member (6a) and a second plane of the second connection-reinforcing member (6b) intersect with each other. According to this structure, the filament is more resistant to swinging and is more stably fixed than the filaments of the conventional lamps, even if the filament is extended in the direction of the tube axis in order to extend the lamp life.

### TECHNICAL FIELD

The present invention relates to a hot cathode discharge lamp, and more particularly to a technique to stabilize electrodes.

### BACKGROUND ART

Liquid crystal display apparatuses such as liquid crystal display televisions and liquid crystal display monitors have become remarkably popular in recent years, and demand for backlight units used for such liquid crystal display apparatuses is increasing.

Conventionally, a cold cathode discharge lamp is frequently used as a light source of a backlight unit. However, as the size of liquid crystal display televisions has become larger recently, application of a hot cathode discharge lamp to a relatively large backlight unit is being studied. The hot cathode discharge lamps have been commonly used for lighting.

Since a hot cathode discharge lamp achieves higher luminous efficiency and emits more amount of light per single lamp than a cold cathode discharge lamp, the hot cathode discharge lamp has an advantage of preventing increase of the number of lamps needed for a backlight unit. To the contrary, it has a disadvantage of having a short lamp life. As it is not easy to replace the light source of the backlight unit with a new one, it is strongly requested to create a hot cathode discharge lamp with a longer operating life.

It is also generally known that a hot cathode discharge lamp come to the end of its life because an emitter is consumed during the operation, especially at start-up, and accordingly, the emitter used for the operation in the electrodes runs out as the operation continues. To extend the operating life of a hot cathode discharge lamp, it is necessary to have the electrodes holding larger amount of the emitter than the conventional amount or to prevent the emitter from running out.

In order to extend the operating life and reduce the diameter of a hot cathode discharge lamp, the patent document 1 discloses a discharge lamp in which a coil part (filament) is placed parallel to the axis of a glass tube. The patent document 1 discusses as follows. “Although ions generated during discharge generally collide with the electrodes and thus contribute to scattering of the electron emission material, the ions specifically collide mainly with a forward end of a coil portion of each of the electrodes because the coil portion is arranged parallel to a tube axis of a glass tube. Therefore, the electron emission material is inhibited from being scattered along a major part of the coil portion” (paragraph 17 and so on). Patent document 1: Japanese Laid-open Patent Application Publication No. 2005-235749

### DISCLOSURE OF THE INVENTION

### Problems to be Solved by the Invention

The invention of the patent document 1, however, is not suitable to hold a large amount of the emitter, because the shape of a filament is unstable as it is extended.

In addition, in the embodiment of the patent document 1, two pieces of connection-reinforcing members are used. However, these connection-reinforcing members are flat plates and simply placed in the same direction as the lead wires and the lead-in wires are arranged. The electrode having such structure easily swings in the vertical direction. Due to such swinging, the filament or a part of the connection-reinforcing members might touch an inner surface of a sleeve or a glass tube that are placed surrounding the filament and the connection-reinforcing members. If this happens, the temperature of the filament decreases, the electron emission efficiency declines and also scattering of the emitter by ionic collision is promoted. Any kind of measure is demanded to solve these problems.

The present invention aims to provide a hot cathode discharge lamp that is more resistant to swinging and capable of more stably fixing a filament thereof compared to the conventional one, even if the filament is extended to the direction parallel to the tube axis in order to extend the lamp life.

### Means to Solve the Problem

In order to achieve the above object, the present invention provides a hot cathode discharge lamp including an electrode, the electrode having a filament coil, a first connection-reinforcing member, a second connection-reinforcing member, a first lead-in wire, and a second lead-in wire, the filament coil including: a coil part to which an emitter is attached; a first lead wire that extends from one of two ends of the coil part, and is connected to the first lead-in wire via the first connection-reinforcing member; and a second lead wire that extends from an other one of the two ends of the coil part, and is connected to the second lead-in wire via the second connection-reinforcing member, wherein the first lead-in wire and the second lead-in wire supply electric power from an external power source, the coil part is a multiple-coiled coil, an axis of a most external winding of the coil part is identical or substantially parallel to a tube axis of the lamp, the most external winding having a widest winding diameter among windings in the multiple-coiled coil, each of the first connection-reinforcing member and the second connection-reinforcing member includes a main structure having a flat-plate shape, and a first plane and a second plane intersect with each other, the first plane being an imaginary plane that is expanded from a major surface of the main structure of the first connection-reinforcing member, and the second plane being an imaginary plane that is expanded from a major surface of the main structure of the second connection-reinforcing member.

### EFFECTS OF THE INVENTION

According to the structure described above, the first connection-reinforcing member and the second connection-reinforcing member are not arranged in the same direction as the lead wires and the lead-in wires are arranged, and they are arranged so as to form a certain angle. Because of this arrangement, the filament is resistant to swinging in any direction. Also, the filament can be fixed stably, and it is possible to have the filament hold larger amount of the emitter than the conventional lamps.

The hot cathode discharge lamp of the present invention, wherein each of the first plane and the second plane may be vertical to a tube cross-section that is vertical to the tube axis of the lamp, and a line as an intersection of the first plane and the second plane may be substantially parallel to the tube axis of the lamp.

According to the above structure, the first connection-reinforcing member and the second connection-reinforcing member are arranged so as to form a certain angle on a surface that is parallel to the cross-section of the lamp tube. Because of this, the filament can be fixed stably.

The hot cathode discharge lamp of the present invention, wherein the first plane and the second plane may intersect at a substantially right angle.

According to this structure, the first connection-reinforcing member and the second connection-reinforcing member intersect at a substantially right angle so as to form the shape of “inverted V” or “T” etc. on the surface that is parallel to the cross-section of the lamp tube. Because of this, the filament is resistant to swinging in any direction.

The hot cathode discharge lamp of the present invention, wherein each of the first connection-reinforcing member and the second connection-reinforcing member may include a sub structure, the sub structure having at least a part that is not a plane that is vertical to the tube axis of the lamp.

According to this structure, the sub structure enhances the strength against swinging, and the filament is resistant to swinging in any direction.

The hot cathode discharge lamp of the present invention, wherein each of the first connection-reinforcing member and the second connection-reinforcing member may have been formed from a flat plate, and the sub structure may be a part that has been formed by applying one of processes of bending, ribbing, and twisting to the flat plate.

Accordingly, the main structure and the sub structure are easily formed from a single flat plate.

The hot cathode discharge lamp of the present invention, wherein the sub structure of the first connection-reinforcing member may be a part that has been formed in such a manner that at least one of the first lead wire and the first lead-in wire is fixed to the main structure by crimping, and the sub structure of the second connection-reinforcing member may be a part that has been formed in such a manner that at least one of the second lead wire and the second lead-in wire is fixed to the main structure by crimping.

Accordingly, formation of the substructure and connection of the lead wire or the lead-in wire can be done at the same time.

### BRIEF DESCRIPTION OF THE DRAWINGS

FIG. 1 is a cross-sectional view showing an overall structure of a hot cathode discharge lamp pertaining to the embodiment 1 of the present invention;

FIG. 2 is a magnified view of an electrode unit 3a and the surrounding part thereof;

FIG. 3 is a perspective view of the electrode unit 3a of the embodiment 1;

FIG. 4 is a cross-sectional view along a virtual surface A in FIG. 3;

FIG. 5 is a perspective view of an electrode unit 3a of the modification 1;

FIG. 6. is a cross-sectional view along a virtual surface B in FIG. 5;

FIGS. 7A to 7D show a first connection-reinforcing member 5a and a second connection-reinforcing member 5b of the modification 2; and

FIGS. 8A to 8D show a second connection-reinforcing member 5b of the modification 3.

### DESCRIPTION OF REFERENCE NUMERALS

1 hot cathode discharge lamp
2 glass tube
2a phosphor layer
3a electrode unit
3b electrode unit
4a coil
4b first lead wire
4c second lead wire
5a first connection-reinforcing member
5b second connection-reinforcing member
6a first lead-in wire
6b second lead-in wire
7 sleeve
8 sleeve lead

### BEST MODE FOR CARRYING OUT THE INVENTION

### Embodiment 1

### Outline

A hot cathode discharge lamp pertaining the embodiment 1 of the present invention has the following structure. An electrode used in the hot cathode discharge lamp has a filament coil whose most external winding is wound in the direction of a tube axis of the lamp such that the filament coil extends parallel to the tube axis. Two flat-plate connection-reinforcing members are used to connect two lead wires of the filament coil to two lead-in wires respectively. In the conventional art, these connection-reinforcing members are arranged in the same direction as the lead wires and the lead-in wires are arranged. However in the present invention, the connection-reinforcing members are arranged in such a manner that two flat surfaces that respectively include major surfaces of the connection-reinforcing members intersect with each other. In other words these two surfaces form the shape of an “inverted V” or a “T” when shown in the cross-sectional view. According to this structure, the filament coil can be more resistant to swinging and more stably fixed than the conventional one, even if the filament coil is arranged in the longitudinal direction.

### <Structure>

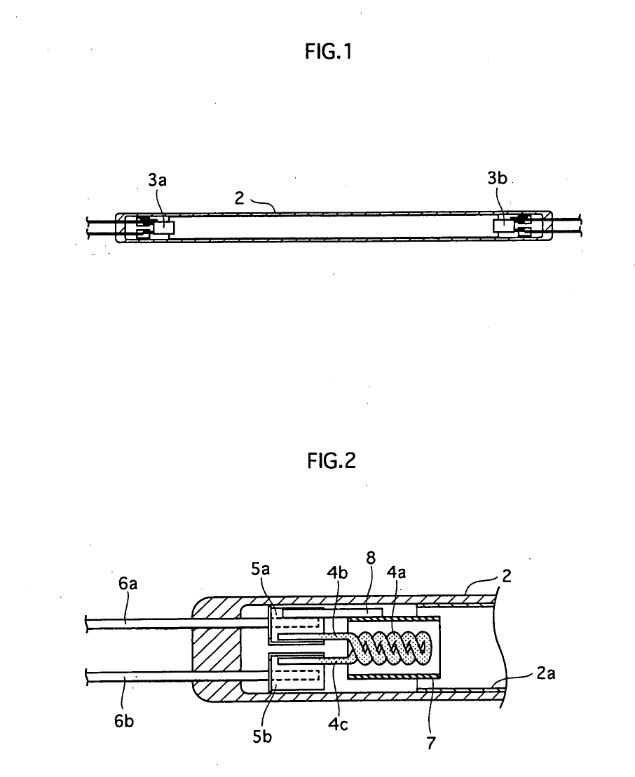

FIG. 1 is a cross-sectional view showing an overall structure of a hot cathode discharge lamp pertaining to the embodiment 1 of the present invention.

As FIG. 1 shows, the hot cathode discharge lamp pertaining to the embodiment 1 of the present invention is equipped with a glass tube 2, and electrode units 3a and 3b of hot cathode type that are separately placed at two opposite ends of the glass tube.

The glass tube 2 is, for example, a substantially cylindrical envelope whose outside diameter is 8 mm, thickness 0.8 mm and length 740 mm, and encloses a light-emitting material and buffer gas in an internal space thereof. The light-emitting material is mercury (e.g. approximately 4 to 10 mg) that contributes to emission of light, and the buffer gas is, for example, a mixture gas of 50% argon and 50% krypton (e.g. gas pressure approximately 600 Pa).

On the inner surface of the glass tube 2, a phosphor layer 2a is formed. The phosphor layer converts ultraviolet rays emitted from the mercury to visible light. The phosphor layer 2a is made from a rare-earth phosphor that is a mixture of, for example, a red phosphor (Y₂O₃: Eu), a green phosphor (LaPO₄:Ce, Tb), and a blue phosphor (BaMg₂Al₁₆O₂₇:Eu, Mn).

Since the main parts of the electrode unit 3a and the electrode unit 3b have an identical structure, only the electrode unit 3a is described below.

FIG. 2 is a magnified view of the electrode unit 3a and the surrounding part thereof.

As FIG. 2 indicates, the electrode unit 3a consists of a filament coil, a first connection-reinforcing member 5a, a second connection-reinforcing member 5b, a first lead-in wire 6a, a second lead-in wire 6b, a sleeve 7, and a sleeve lead 8. The filament coil consists of a coil 4a, a first lead wire 4b extending from one end of the coil 4a, and a second lead wire 4c extending from the other end of the coil 4a.

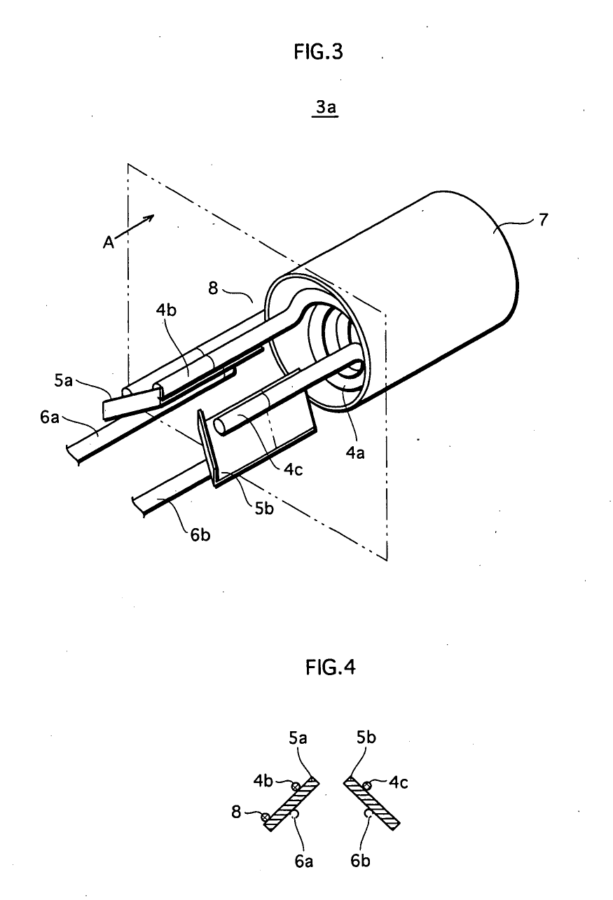

FIG. 3 is a perspective view of the electrode unit 3a of the embodiment 1.

FIG. 4 is a cross-sectional view of the electrode unit 3a along the virtual surface A in FIG. 3.

The filament coil (consisting of the coil 4a, the first lead wire 4b and the second lead wire 4c) is a multiple-coiled coil (that is, a coiled coil or more) and made of tungsten. The windings of the filament coil has a single helical structure, and a central space of each internal winding, except that of the most external winding, is filled with an electron emission material (known as “emitter”) such as BaO, CaO, and SrO. Here, in the case of a coiled coil, the most external winding means a winding that is wound secondly so as to have a wider diameter than the firstly wound winding, and that of a triple-coiled coil means a winding that is wound thirdly so as to have the widest diameter among the three windings. The axis of the most external winding is substantially identical or parallel to the tube axis of the lamp. For example, a triple-coiled coil has the following structure. The filament is wound spirally to form a single coil, then the single coil is further wound spirally to form a coiled coil, and the coiled coil is again wound spirally to form a triple-coiled coil. A main wire runs through a central space of the first winding, and the first winding and the second winding are filled with the electron emission material 110.

The first connection-reinforcing member 5a and the second connection-reinforcing member 5b are made of metal that mainly consist of stainless steel (SUS304) and so on. Each of the connection-reinforcing members has a flat-plate main structure, and is used to fix the filament coil and the sleeve 7 in a stable and easy mariner. The first lead wire 4b, the first lead-in wire 6a and the sleeve lead 8 are welded to the first connection-reinforcing member 5a, and these parts are connected with each other electrically and structurally. The second lead wire 4c and the second lead-in wire 6b are welded to the second connection-reinforcing member 5b, and these parts are connected with each other electrically and structurally. In this way, the connection-reinforcing members directly support the filament coil and the sleeve 7.

The first lead-in wire 6a and the second lead-in wire 6b are metallic wires, and have rigidity to the extent that the wires are not deformed in general use. The first lead-in wire 6a and the second lead-in wire 6b conduct the electricity provided from outside of the hot cathode discharge lamp 1 to the filament coil through the first connection-reinforcing member 5a and the second connection-reinforcing member 5b. The first lead-in wire 6a and the second lead-in wire 6b directly support the first connection-reinforcing member 5a and the second connection-reinforcing member 5b respectively at each connection point.

The sleeve 7 is made of metal such as nickel (Ni) and molybdenum. The sleeve 7 is a cylindrically-shaped structural part, having openings at its two opposite ends, and is placed surrounding the coil 4a to prevent scattering of the emitter.

The sleeve lead 8 is a substantially cylindrical metallic rod made of mainly stainless steel (SUS304) and so on. The sleeve lead 8 is welded to the sleeve 7 at one end and to the first connection-reinforcing member 5a at the other end to fix the sleeve 7.

Conventionally, the first connection-reinforcing member 5a and the second connection-reinforcing member 5b are arranged in the same direction as the first and second lead wires 4b and 4c and the first and second lead-in wires 6a and 6b. However here in the present invention, the first connection-reinforcing member 5a and the second connection-reinforcing member 5b are arranged in such a way where a first plane that includes the major surface of the main structure of the first connection-reinforcing member 5a and a second plane that includes the major surface of the main structure of the second connection-reinforcing member 5b intersect with each other, in order to improve the strength against swinging in any direction.

As clearly shown in FIG. 3 and FIG. 4, the first connection-reinforcing member 5a and the second connection-reinforcing member 5b in the electrode unit 3a of the embodiment 1 are arranged in a way that they form the shape of “inverted V”. In other words, the first connection-reinforcing member 5a and the second connection-reinforcing member 5b are arranged in such a way where a line as the intersection of the first plane and the second plane becomes substantially parallel to the tube axis, and these two planes intersect at a substantially right angle. With this structure, the filament can further be stably fixed and resistant to swinging in any direction.

### <Summary>

As described above, the hot cathode discharge lamp of the embodiment 1 has the first connection-reinforcing member 5a and the second connection-reinforcing member 5b that are arranged in a way that they make a certain angle. As a result, the filament is resistant to swinging in any direction and fixed stably, and more electron emission material can be attached to the filament than the conventional art.

Accordingly, the electrodes can hold more amount of electron emission material than the conventional lamps, and it is possible to extend the operating life of the hot cathode discharge lamp to be longer than the conventional lamps.

### Modification 1

FIG. 5 is a perspective view of an electrode unit 3a of the modification 1.

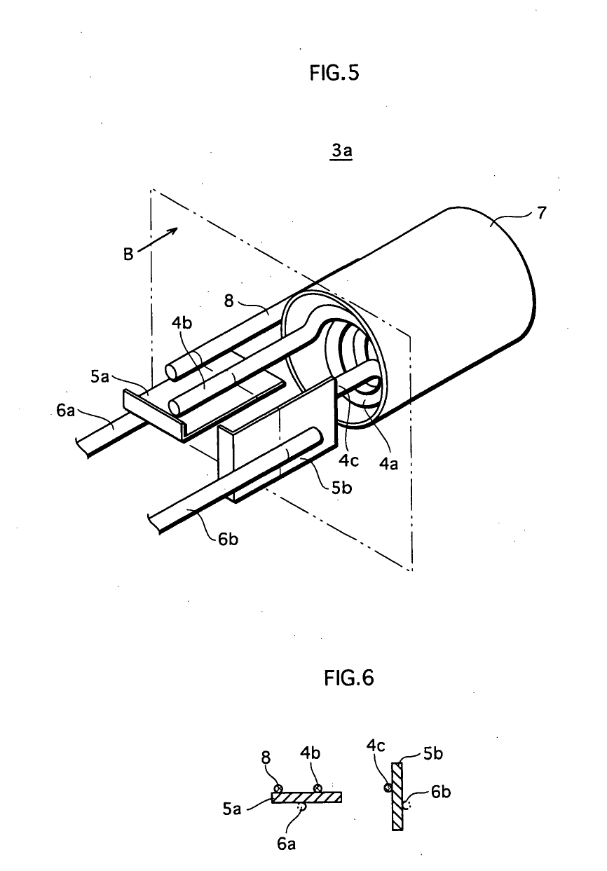

FIG. 6 is a sectional view along the virtual surface B in FIG. 5.

As is clearly shown in FIG. 5 and FIG. 6, a first connection-reinforcing member 5a and a second connection-reinforcing member 5b in the electrode unit 3a of the modification 1 are arranged in a way they form the shape of “T”. This arrangement is the same as the embodiment 1 in that a line as the intersection of the first plane and the second plane becomes substantially parallel to the tube axis, and these two planes intersect at a substantially right angle. This arrangement is effective because the filament can be fixed stably and resistant to swinging in any direction.

### Modification 2

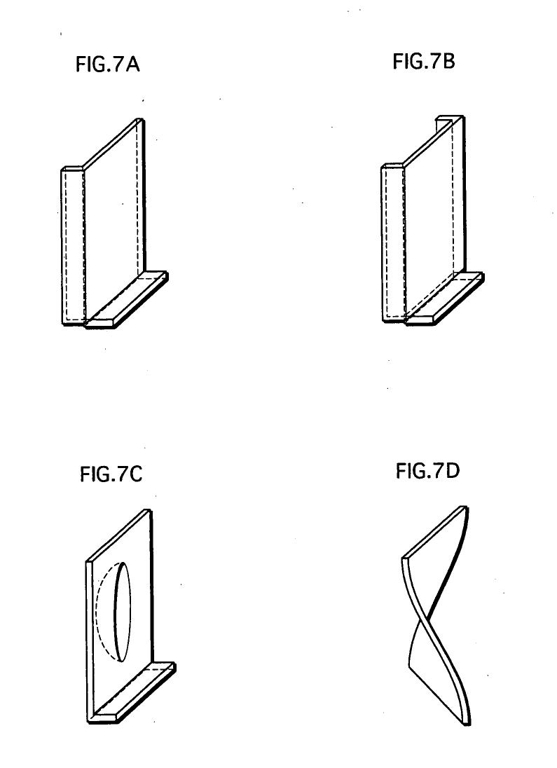

FIGS. 7A to 7D show a first connection-reinforcing member 5a and a second connection-reinforcing member 5b of the modification 2.

FIG. 7A is a connection-reinforcing member made from a flat plate which is bent to form a sub structure in addition to a main structure. The sub structure is not vertical to the tube axis and has a part extending to a direction different from the main structure.

FIG. 7B is a connection-reinforcing member made from a flat plate which is bent to form two sub structures in addition to a main structure. Each of the sub structures is not vertical to the tube axis and has a part extending to a direction different from the main structure.

FIG. 7C is a connection-reinforcing member made from a flat plate which is ribbed to form a sub structure in addition to a main structure. The sub structure is not vertical to the tube axis and has a part extending to a direction different from the main structure.

FIG. 7D is a connection-reinforcing member made from a flat plate which is twisted to form a sub structure in addition to a main structure. Each of the main structure and the sub structure includes a part that is not vertical to the tube axis, and has a part extending to a direction different from each other.

As described above, the sub structures in the modification 2 further enhance the strength against swinging, and accordingly the electrode can be resistant to swinging in any direction. In addition, the main structures and the sub structures are easily formed from one piece of plate, and because of this, formation is relatively easy.

### Modification 3

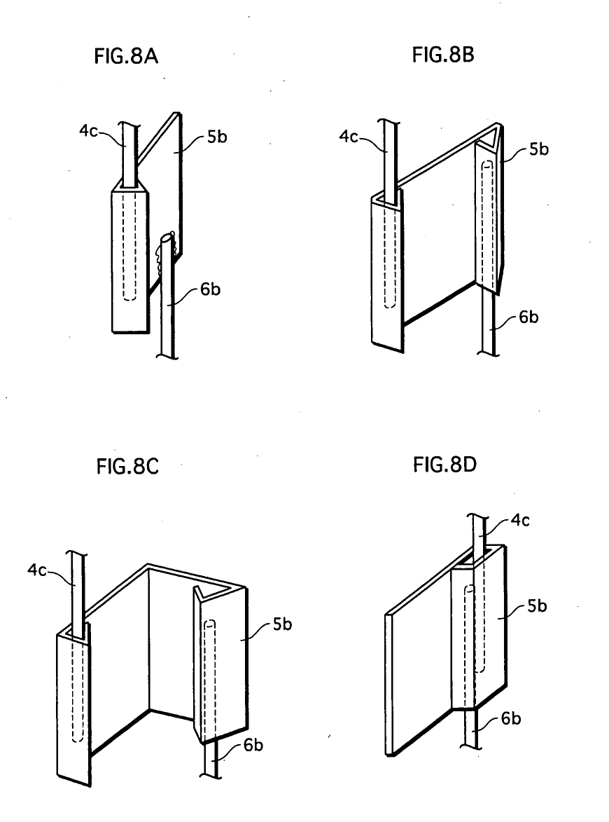

FIGS. 8A to 8D show a second connection-reinforcing member 5b of the modification 3.

FIG. 8A is the second connection-reinforcing member 5b to which a second lead wire 4c is not welded but connected by swaging. A flat plate is bent to form a fastening part that works as a fastener, and the second lead wire 4c is connected by swaging the fastening part.

FIG. 8B is the second connection-reinforcing member 5b to which not only the second lead wire 4c but also a second lead-in wire 6b is connected by swaging, not by welding. A flat plate is bent to form two fastening parts that work as the fasteners, and the second lead wire 4c and the second lead-in wire 6b are connected by swaging the respective fastening parts.

FIG. 8C is the second connection-reinforcing member 5b that is bent prior to connecting the second lead wire 4c and the second lead-in wire 6b. These wires are connected by swaging as shown in FIG. 8B.

FIG. 8D is the second connection-reinforcing member 5b to which the second lead wire 4c and the second lead-in wire 6b are connected by swaging of the same fastening part.

As described above, the sub structures of the modification 3 are formed as the fastening parts that connect the lead wire or the lead-in wire. In this way, the sub structures of the modification 3 achieve the same effect as the modification 2.

Note that the first connection-reinforcing member 5a of the modification 3 is identical to the second connection-reinforcing member 5b except that the first connection-reinforcing member 5a has the sleeve lead 8 connected by welding or squeezing.

### INDUSTRIAL APPLICABILITY

The present invention can be widely applied to various devices including back light units that use hot cathode discharge lamps, or to the hot cathode discharge lamps. The present invention can provide a hot cathode discharge lamp that is more resistant to swinging, capable of more stably fixing a filament, and capable of extending an operating life to be longer than the convention alone. Accordingly, the hot cathode discharge lamp of the present invention can broaden the range of application, and has an extremely high industrial utilization value.

1. A hot cathode discharge lamp including an electrode, the electrode having a filament coil, a first connection-reinforcing member, a second connection-reinforcing member, a first lead-in wire, and a second lead-in wire, the filament coil including:
a coil part to which an emitter is attached;
a first lead wire that extends from one of two ends of the coil part, and is connected to the first lead-in wire via the first connection-reinforcing member; and
a second lead wire that extends from an other one of the two ends of the coil part, and is connected to the second lead-in wire via the second connection-reinforcing member, wherein
the first lead-in wire and the second lead-in wire supply electric power from an external power source,
the coil part is a multiple-coiled coil,
an axis of a most external winding of the coil part is identical or substantially parallel to a tube axis of the lamp, the most external winding having a widest winding diameter among windings in the multiple-coiled coil,
each of the first connection-reinforcing member and the second connection-reinforcing member includes a main structure having a flat-plate shape, and
a first plane and a second plane intersect with each other, the first plane being an imaginary plane that is expanded from a major surface of the main structure of the first connection-reinforcing member, and the second plane being an imaginary plane that is expanded from a major surface of the main structure of the second connection-reinforcing member.

2. The hot cathode discharge lamp of claim 1, wherein
each of the first plane and the second plane is vertical to a tube cross-section that is vertical to the tube axis of the lamp, and
a line as an intersection of the first plane and the second plane is substantially parallel to the tube axis of the lamp.

3. The hot cathode discharge lamp of claim 2, wherein
the first plane and the second plane intersect at a substantially right angle.

4. The hot cathode discharge lamp of claim 1, wherein
each of the first connection-reinforcing member and the second connection-reinforcing member includes a sub structure, the sub structure having at least a part that is not a plane that is vertical to the tube axis of the lamp.

5. The hot cathode discharge lamp of claim 4, wherein
each of the first connection-reinforcing member and the second connection-reinforcing member has been formed from a flat plate, and the sub structure is a part that has been formed by applying one of processes of bending, ribbing, and twisting to the flat plate.

6. The hot cathode discharge lamp of claim 4, wherein
the sub structure of the first connection-reinforcing member is a part that has been formed in such a manner that at least one of the first lead wire and the first lead-in wire is fixed to the main structure by crimping, and
the sub structure of the second connection-reinforcing member is a part that has been formed in such a manner that at least one of the second lead wire and the second lead-in wire is fixed to the main structure by crimping.
